(19) United States
(12) Patent Application Publication
(10) Pub. No.: US 2003/0167887 A1
(43) Pub. Date: Sep. 11, 2003

(54) Product separation apparatus and method

(76) Inventor: Tad T. Butterworth, Ashland, WI (US)

Correspondence Address: Gerald L. Fellows, Michael Best & Friedrich LLP, 100 East Wisconsin Avenue, Milwaukee, WI, 53202-4108, US

(21) Appl. No.: 10/092,337

(22) Filed: Mar. 6, 2002

(51) Int. Cl. B26D 7/06; B26D 7/18

(52) U.S. Cl. 83/27; 83/155.1

(57) ABSTRACT

An apparatus and method for removing trim from logs of sheet material. In some embodiments, the apparatus has a first axle defining a first axis, a second axle defining a second axis, a first guide assembly, a second guide assembly, a conveyor extending across the first and second axles and through the first and second guide assemblies so that the first guide assembly and the first axle define a first section of the conveyor, the second guide assembly and the second axle define a second section of the conveyor, and the first guide assembly and the second guide assembly define a third section of the conveyor below the second section. One or both of the first and second guide assemblies are preferably movable to discharge trim from the apparatus. In some embodiments, the conveyor includes first and second endless members.

### FIELD OF THE INVENTION

The present invention relates generally to devices and methods for processing web product, and more particularly to devices and methods for separating a portion of web product from a stream of web product.

### BACKGROUND OF THE INVENTION

Web products are typically manufactured in relatively large quantities in the form of stacks or rolls, which are usually moved along a line or a conveyor from upstream operations to downstream operations. At some point during the manufacturing process, these relatively large stacks or rolls are often cut into smaller product units. These product units are then passed on to downstream operations, such as for example, packaging, wrapping, finishing, bundling, labeling, printing, and other operations. One such downstream operation typically involves separating the product units from waste product. Generally, during the cutting operation waste product is generated which must be carefully separated from the product units. During this culling process, care must be taken to avoid inadvertent removal of product units.

As mentioned above, web products are often manufactured in relatively large rolls, which are commonly referred to as “logs”. Alternatively, web products may be manufactured in other forms, such as stacks or bundles. Logs of web product are therefore found in a number of different shapes, sizes, and forms. As used hereafter and in the appended claims, the term “log” is meant to include quantities of web product wound, stacked, or otherwise collected in any form and is not meant to be limited to rolls of web product. Moreover, the term “log” as used herein and in the appended claims does not indicate or imply any particular shape of product or number of individual units making up such product. In addition, the term “log” is meant to include web product which is defined by one or more units (e.g., napkins, towels, and the like) collectively taking virtually any shape, length, width, or depth.

Similarly, as used herein and in the appended claims, the terms “web” and “web product” are meant to include paper products such as napkins, paper towels, facial tissue, toilet tissue, newsprint, and the like. Also, because the problems described below and advantages of the present invention are not limited to paper products, the terms “web” and “web product” are meant to include products which are made from other materials and are found in sheet form, including without limitation cellophane, plastic sheeting, and other synthetic materials, fabric, woven, and non-woven textiles and cloth, foil, etc., regardless of product porosity, density, and dimensions.

As mentioned above, during the cutting operations material is removed from the logs and from product units cut from the logs. This material can be intended for use or for destruction and is referred to hereafter and in the appended claims as “trim.” Similarly, the process of removing trim from the logs is referred to herein as “trimming,” regardless of the particular cutting implement or device used, the quantity of trim removed from the log, or when during the manufacturing process the trimming operation occurs.

The ever-increasing demands placed upon web product manufacturing apparatuses can present challenging machine design problems. In particular, many applications require manufacturing speeds demanding fast and efficient machine functions that can be at odds with trim separation and removal operations. As mentioned above, it is generally necessary to separate trim from the product units while simultaneously avoiding inadvertent removal of product units. This problem becomes increasingly difficult at increased speeds and can result in increased waste.

Moreover, web material is often manufactured in multiple production lines which include multiple machines or apparatuses operating together. The lines can be synchronized so that the machines and apparatuses operate together at the same or similar speeds and so that no one machine or apparatus operates faster or slower than any other machine or apparatus. This is frequently done to prevent bottlenecks and jams. Therefore, the speed of the entire line is often dictated by the operating speed of the slowest machine. In some cases, the machines and apparatuses which perform trimming and culling operations are the slowest machines in the line of web product production. Therefore, these machines and apparatuses can slow the entire line to their relatively slow operating speeds, thereby significantly reducing the productivity of a given line.

In addition, systems and devices capable of performing trimming and culling operations at high speeds are typically quite complex and therefore are often relatively difficult to manufacture and repair. Thus, these machines can be expensive to manufacture, repair, and maintain. Similarly, these machines and apparatuses can be difficult to adjust or modify when needed to produce a new product or a new version of an existing product.

Profits in the web product industry are increasingly tied to production speeds. It is therefore highly desirable to separate trim from logs as rapidly as possible. In addition, it is highly desirable to minimize waste, which can also have a significant impact on profits.

Regardless of the precautions taken during manufacturing, some web product is inevitably flawed or damaged. In some cases, the flawed or damaged web product may include only small sections of a log. Alternatively, entire logs may be damaged or flawed. It is therefore desirable to design an apparatus capable of removing both relatively small product units and even relatively large logs from the manufacturing apparatus.

The separation of trim, flawed or damaged units, and other web product from a stream of web product is often complicated by the operating speeds of the web manufacturing apparatuses. In particular, the apparatuses often operate at such high speeds that it is difficult for an operator or machine to quickly remove damaged or flawed web product or to distinguish trim from product units. Similarly, it may not be cost effective to address this issue by increasing operator monitoring and intervention or by reducing machine speeds. It is therefore desirable to automate the culling process so that higher operating speeds can be maintained and so that product units can be separated from trim and damaged or flawed logs while minimizing operator input.

In light of environmental concerns and in order to reduce material costs and waste, it is highly desirable to recycle the trim. Before the trim can be recycled, the trim must first be successfully separated from the product units. After the trim is separated, it is desirable to reroute the trim so that the trim can be recycled or so that the trim can be properly disposed. Moreover, it is desirable to identify damaged or flawed product early in the manufacturing operation so as to minimize wasted production time and to minimize material waste.

In light of the problems and limitations of the prior art described above, a need exists for an apparatus and a method capable of removing trim and damaged or flawed logs that employs a simple design, which is easy to assemble, maintain, and repair, is able to remove trim and/or damaged, or flawed logs or log portions from the manufacturing line, and is capable of high operational speeds. Each preferred embodiment of the present invention achieves one or more of these results.

### SUMMARY OF THE INVENTION

Some preferred embodiments of the present invention employ a log saw or other product separation apparatus to separate product units from a log and to cut trim and damaged or flawed units from logs. The product separation apparatus of the present invention can then preferably remove damaged or flawed log parts and units from a web manufacturing apparatus. Preferably, the product separation apparatus can even be employed to remove entire logs, if needed or desired. In some embodiments, the product separation apparatus can be employed to accurately and quickly divert usable product (e.g., a stream of product units cut from a log) away from a stream of other usable product, such as to divert some product units to another operation. The product separation apparatus can be located relatively near or adjacent other sheet product manufacturing, packaging, or processing equipment. More particularly, the product separation apparatus preferably operates in conjunction with these other devices to produce, manufacture, or finish web products.

Logs are generally cut into product units and trim is typically removed from the product units upstream from the product separation apparatus. Preferably, a log saw or other cutting device is employed to perform this function. Alternatively, the cutting device can include multiple blades or knifes or the cutting device can include other cutting elements such as lasers, wire cutting elements, or any other apparatus capable of cutting logs.

The product separation apparatus preferably receives logs, product units, and trim from upstream operations via a feed conveyor, such as for example, a conveyor belt or an elevator. Typically, the feed conveyor transports the product units, trim, and damaged or flawed logs to the product separation apparatus so that trim and/or flawed or damaged logs can be separated from the product units. In some highly preferred embodiments, the feed conveyor moves the logs through the cutting device and then moves the trim, product units, and any damaged or flawed logs on to the product separation apparatus.

In some preferred embodiments, the product separation apparatus preferably includes a first pulley, a second pulley, a third pulley, a fourth pulley, a first guide assembly positioned between the first and third pulleys and the second and fourth pulleys, a second guide assembly adjacent the first guide assembly, and a first endless member extending about the first and second pulleys and through the first and second guide assemblies, and a second endless members extending about the third and fourth pulleys and through the first and second guide assemblies. In different embodiments, the first and second endless members can have different shapes and orientations. In some highly preferred embodiments, the first and second endless members are conventional conveyor belts. The first and second endless members can be made from a series of individual or separate elements coupled together, such as for example, a chain or a tabletop conveyor. Most preferably, the first and second endless members are relatively narrow elongated members such as ropes, cords, cables, chains, wires, belts, bands, and the like. The first endless member is preferably formed by coupling the two ends of an elongated member together to form a loop. In a similar manner, the second endless member is preferably formed by coupling the two ends of an elongated member together to form another loop.

The first and second endless members are preferably substantially parallel and preferably extend across the first and second pulleys and the third and fourth pulleys, respectively. A portion of each of the first and second endless members is preferably adjacent the feed conveyor. The feed conveyor preferably passes product units, trim, and any damaged or flawed logs onto the first and second endless members.

Preferably, the first pulley is rotated about its own axis by a prime mover or by one of the first and second endless members. The third pulley is also preferably rotated about its own axis by a prime mover or by one of the first and second endless members. In alternative embodiments of the present invention, the third and/or the fourth pulleys can also or alternatively be rotated about their own axes by a prime mover or by one of the first and second endless members. In still other embodiments additional pulleys can also or alternatively be used to support or to guide portions of the first and second endless members. To drive the first and second endless members, the prime mover can be connected to and rotate the first pulley, the second pulley, the third pulley, the fourth pulley and/or a rotating element, in the first or second guide assemblies.

Preferably, the first guide assembly is moveable between the first and second pulleys and the third and fourth pulleys. In some embodiments, the first guide assembly includes a first pulley and a second pulley about which the first and second endless members pass. The second guide assembly is preferably positioned between the first guide assembly and the second and fourth pulleys. At least a portion of each of the first and second endless members preferably extends through the second guide assembly. In some embodiments, the second guide assembly includes a third pulley and a fourth pulley about which the first and second endless members pass. The second guide assembly is preferably moveable between the first and third pulleys and the second and fourth pulleys.

In some highly preferred embodiments, the first, second, third, and fourth pulleys and the first and second guide assemblies define sections of the first and second endless members. A first conveyor section is preferably defined by the portions of the first and second endless members located between the first pulley and the second guide assembly and between the third pulley and the second guide assembly. The feed conveyor preferably transfers product units, trim, and logs onto the first conveyor section. A second conveyor section is preferably defined by the portions of the first and second endless members between the second pulley and the first guide assembly and between the fourth pulley and the first guide assembly. The first and second guide assemblies preferably define a third conveyor section therebetween. In some preferred embodiments, the third section is between and below the first and second sections.

The assembly defined by the first and second endless members, the first, second, third, and fourth pulleys, and the first and second guide assemblies is preferably moveable between a first state and a second state so that the apparatus can separate trim and acceptable, damaged, or flawed product units and logs. When the assembly is shifted into the first state, product units can move through the product separation apparatus without being diverted. Alternatively, when the assembly is shifted into the second state, trim and acceptable, damaged, or flawed product units and logs are preferably unable to pass undiverted through the product separation apparatus and instead are removed therefrom.

In particular, when the assembly is shifted between the first and second states, the first guide assembly preferably moves laterally between the first and third pulleys and the second and fourth pulleys, alternately separating and adjoining the first and second sections and alternately lengthening and shortening the first and third conveyor sections. Preferably, when the assembly is in the first state, the first section and the second section are adjacent one another. Conversely, when the assembly is in the second state, the first section and the second section are spaced a distance apart.

In operation, the assembly defined by the first and second endless members, the first, second, third, and fourth pulleys, and the first and second guide assemblies is preferably in the first state to receive product units from the feed conveyor. Preferably, before or while trim and/or damaged or flawed product units (or product that otherwise needs to be diverted) enter the product separation apparatus, the apparatus is moved into the second state. In the second state, the first and second sections are spaced a distance apart, thereby causing the trim and/or damaged or flawed product units to fall between the first and second sections onto the third conveyor section. A pusher, such as for example a mechanical arm, a blast of air, a finger, a paddle, or another similar material moving device preferably removes trim or damaged or flawed logs from the third conveyor section. In some preferred embodiments, the trim falls between the first and second conveyor sections and continues past or through the third conveyor section between the first and second endless members, as described in greater detail below. When the trim or the damaged or flawed logs have fallen away or have otherwise been removed, the assembly is preferably moved back into the first state so that the product units can be passed from the first section to the second section.

In some highly preferred embodiments, the first and second endless members are spaced a first distance apart in the first conveyor section. Preferably, the first and second endless members are sufficiently close in the first conveyor section to support logs, trim, and product units and so that the logs, trim, and product units do not fall between the first and second endless members. Preferably, the first and second endless members are substantially parallel through the majority or all of the length of the first conveyor section so that the distance between the first and second endless members remains relatively constant throughout the first conveyor section. Also, the first and second endless members are preferably spaced a similar distance apart in the second conveyor section so that the second conveyor section can also support product units, logs, and trim. The first and second guide assemblies preferably hold the first and second endless members a second distance apart in the third conveyor section. Preferably, the second distance is greater than the first distance. Most preferably, when trim and/or damaged or flawed logs fall from the first conveyor section onto the third conveyor section, the trim and/or logs fall between the first and second endless members. In this manner, trim and/or flawed or damaged logs can be removed from the product separation apparatus.

In some preferred embodiments of the present invention, the second guide assembly is moveable between the first and third pulleys and the second and fourth pulley, alternately separating and adjoining the first and second sections and alternately lengthening and shortening the second and third conveyor sections.

In still other preferred embodiments of the present invention, the first and second guide assemblies are both moveable between the first and third pulleys and the second and fourth pulleys. In this manner, the first and second guide assemblies can alternately separate and adjoin the first and second conveyor sections and can alternately lengthen and shorten the first and second conveyor sections, respectively. Similarly, the first and second guide members preferably can cooperate to alternately lengthen and to shorten the third conveyor section.

Preferably, one or more actuators move the assembly defined by the first and second endless members, the first, second, third, and fourth pulleys, and the first and second guide assemblies between the first state and the second state. For example, an actuator can move the first guide assembly between the first and third pulleys and the second and fourth pulleys. Similarly, an actuator can also or instead move the second guide assembly between the first and third pulleys and second and fourth pulleys. Preferably, the actuators are connected to the guide assemblies and are also connected to carriages which move along track(s) to better control guide assembly movement.

Non-diverted product units leaving the product separation apparatus are preferably transferred to a product conveyor. In some embodiments of the present invention, the product conveyor is positioned immediately adjacent the second and fourth pulleys so that product units can pass directly from the first and second endless members onto the product conveyor. In other embodiments, the product conveyor can be spaced a relatively small distance from the second and fourth pulleys so that product units fall from the first and second endless members onto the product conveyor. The product conveyor then preferably moves the product units to downstream operations (e.g., packaging, finishing, and wrapping operations).

The trim, damaged or flawed product, and/or other diverted product are preferably removed from the product separation apparatus by a trim conveyor. The trim conveyor is preferably a conveyor belt, an elevator, and the like, and is preferably located below the first and second conveyor sections between the first and second guide assemblies. In other embodiments, the trim conveyor can be a turret system, a ramp, a chute, a slide or any other conventional conveying apparatus. During operation, trim, damaged or flawed product, and/or other diverted product can be moved from the first conveyor section onto the third conveyor section and onto the trim conveyor. The trim conveyor then moves such product away from the product separation apparatus to be disposed of, recycled, or transported to downstream operations. In alternative embodiments of the present invention (such as those in which product does not readily fall past the third conveyor section), trim, damaged or flawed product, and/or other diverted product can be removed from the third section by a waste removal device such a movable arm, an intermittent blast of air, a pusher plate, and the like.

The product separation apparatus preferably includes a controller. In different embodiments, the controller can control and coordinate the motion of the feed conveyor, the trim conveyor, the product conveyor, the cutting device, the first guide assembly, and the second guide assembly. Preferably, the controller coordinates the motion of the cutting device and/or the feed conveyor so that different numbers and sizes of logs can be cut into different numbers and sizes of product units and so that different operating speeds can be employed. Similarly, the controller can preferably be set to accommodate logs of different sizes, materials, and lengths. Alternatively or in addition, one or more timers and/or sensors can be employed to coordinate the movements of the cutting device and/or the feed conveyor.

Preferably, the controller can detect the presence of flawed or damaged logs in any conventional manner, such as by optical sensors, measuring devices, and the like connected thereto. Alternatively, an operator can visually inspect logs and product units and can signal the product separation apparatus to reject flawed or damaged logs and product units.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the scope of the present invention.

In the drawings, wherein like reference numerals indicate like parts:

FIG. 1 is a side elevational view of the product separation apparatus according to a preferred embodiment of the present invention;

FIG. 2 is a perspective view of part of the product separation apparatus illustrated in FIG. 1, showing an alternative manner in which the belts can be arranged;

FIG. 3 is a cross-sectional view of part of the product separation apparatus illustrated in FIG. 1, taken along lines III-III of FIG. 1; and

FIGS. 4-9 are plan views of a portion of the product separation apparatus illustrated in FIG. 1, showing the apparatus in progressive steps of operation separating trim from product units.

### DETAILED DESCRIPTION

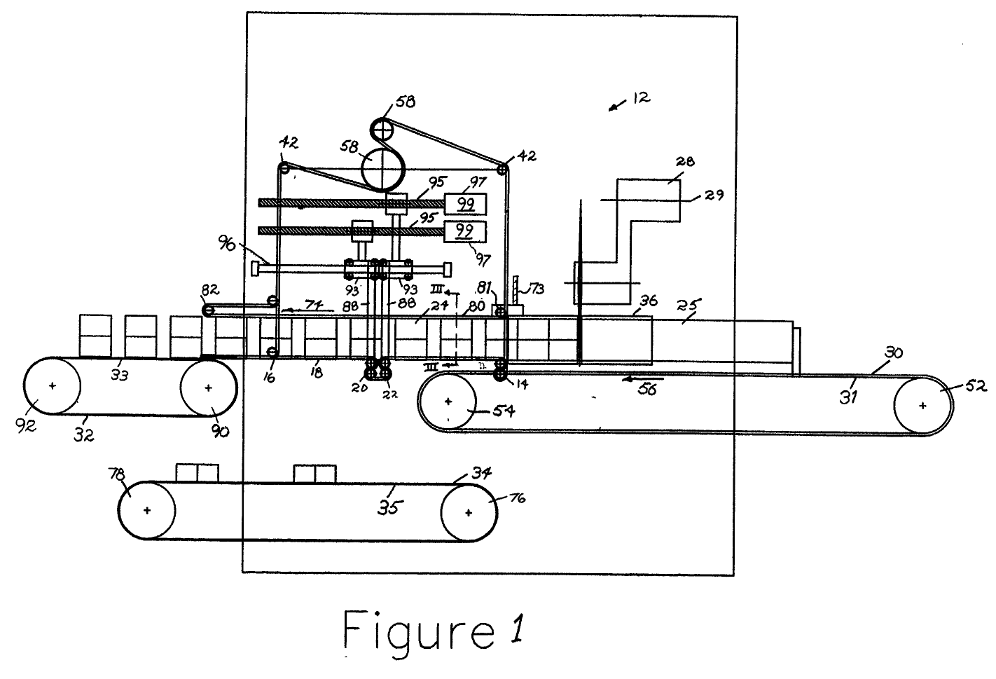

A product separation apparatus according to a preferred embodiment of the present invention is illustrated in FIGS. 1-9. The product separation apparatus 12 of the present invention preferably includes a feed conveyor 30 (see FIG. 1). The feed conveyor 30 preferably brings product in the form of logs 25 to the product separation apparatus 12 from upstream web manufacturing operations, including for example, folding, rolling, interfolding, trimming, and other operations.

FIGS. 1-9 show an embodiment of the present invention in which the feed conveyor 30 includes a belt 31 passed about a first pulley 52 and a second pulley 54. The first and second pulleys 52, 54 are rotatable about their own axes. In other embodiments of the present invention, the first and second pulleys 52, 54 are relatively cylindrical elongated members. For example, the first and second pulleys 52, 54 can be shafts, bars, drums, axles, rollers, and the like, which are preferably rotatable about their own axes.

Preferably, the belt 31 is passed around the first and second pulleys 52, 54 and is held relatively taut by the first and second pulleys 52, 54. More preferably, there is sufficient friction between the inside of the belt 31 and the first and second pulleys 52, 54 so that the belt 31 can frictionally engage the first and second pulleys 52, 54. In this manner, the belt 31 can frictionally drive the first and second pulleys 52, 54. Alternately, one or both of the first and second pulleys 52, 54 can be independently driven so that one or both of the first and second pulleys 52, 54 can frictionally drive the belt 31. One having ordinary skill in the art will appreciate that a number of other manners exist for driving the belt 31 with rotating elements such as shafts, bars, drums, axles, rollers, pulleys, and the like. By way of example only, in some embodiments the first and second pulleys 52, 54 can have teeth which engage the inside of the belt 31.

Rotation of one or both of the first and second pulleys 52, 54 preferably moves the belt 31 along a path 56 (represented by an arrow). In alternative embodiments of the present invention, additional pulleys (not shown) can be positioned between the first and second pulleys 52, 54 to provide additional support to the belt 31 and/or to drive the belt 31 along the path 56.

In some preferred embodiments, the belt 31 is a conventional strap or band formed into a loop by coupling the two ends of the belt 31 together. However, in alternative embodiments of the present invention, the belt 31 can be a series of interconnected elements which form a loop. For example, the belt 31 can be formed by interconnecting a series of elements to form a chain, a sheet of mesh material, or a series of connected elements defining a tabletop conveyor.

In other embodiments of the present invention, the feed conveyor 30 can be any other conventional conveying device. For example, the feed conveyor 30 can be an elevator, a series of powered or unpowered rollers, a slide or chute, and the like. Similarly, the feed conveyor 30 can be a moveable arm, which moves logs 25 from upstream operations to the product separation apparatus 12. Alternatively, the feed conveyor 30 can be a pusher plate which pushes logs 25 along the path 56 and is driven in any conventional manner, such as by a pneumatic or hydraulic piston, a screw drive, a chain or cable drivably connected to a motor, and the like. In short, any product conveyor device or assembly operable to move logs 25 to the product separation apparatus 12 can be employed.

A log saw 28, partially shown in FIG. 1, is preferably positioned along the feed conveyor 30. In alternative embodiments of the present invention, the log saw 28 can be located upstream from the feed conveyor 30 or the log saw 28 can be located downstream from the feed conveyor 30. In still other embodiments, the log saw 28 can be adjacent to the first conveyor section 18A (described in greater detail below). The log saw 28 preferably cuts the logs 25 into product units 24 of a desired size and length and separates and/or removes trim 26 from the logs 25 to form the product units 24. In operation, the log saw 28 preferably rotates about an axis 29 and includes a blade 35 which rotates about its own axis 37. In alternative embodiments of the present invention, the log saw 28 can be any other conventional cutting element. For example, the log saw 28 can be a saw with a saw blade for sawing through logs 25. In other embodiments of the present invention, the log saw 28 can be a laser, a cutting band or wire, or any other cutting element. In still other embodiments, the log saw 28 can be a number of cutting elements operating together to cut logs 25. For example, multiple blades can be spaced along the feed conveyor 30 so that with one or with relatively few passes, the blades can cut a log 25 into the desired number of product units 24. In other highly preferred embodiments, the product separation apparatus 12 can operate in a system without a log saw 28 to sort product units 24.

In some embodiments, the product separation apparatus 12 also includes a log clamp 36 as shown in FIG. 1. The log clamp 36 is preferably positioned along the feed conveyor 30 and the log saw 28. The log clamp 36 preferably holds logs 25 fed by the feed conveyor 30. Preferably, the log clamp 36 holds the logs 25 so that the log saw 28 can cut the logs 25 into product units 24 and so that the logs 25 and the product units 24 are not appreciably deformed or disheveled during cutting.

Preferably, the motion and operation of the feed conveyor 30 and the log saw 28 are coordinated so that the logs 25 can be cut to a desired size. More preferably, the operating speeds of the feed conveyor 30 and the log saw 28 can be adjusted independently or together for different operations, to cut different numbers of units 24 from the same log 25, to cut product units of different sizes, to cut the logs 25 into different numbers of product units 24, and/or to operate selectively at higher and lower saw and conveyor speeds.

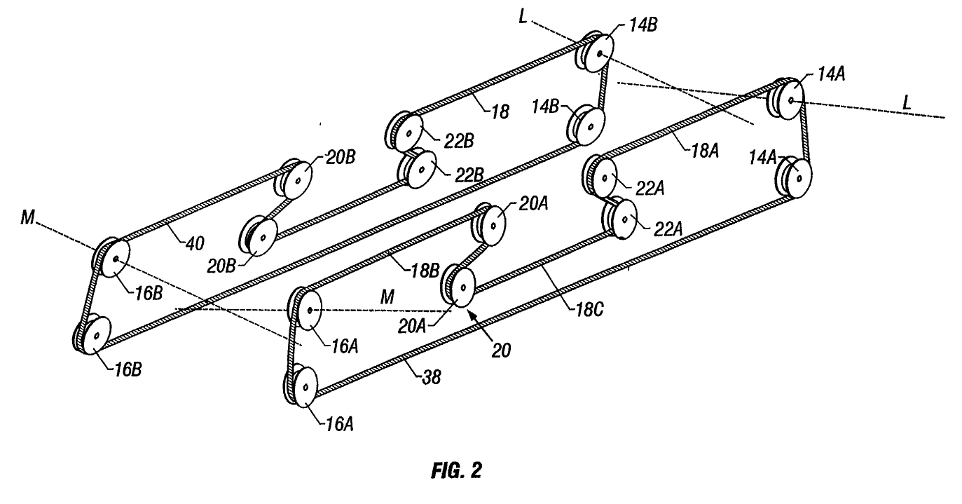

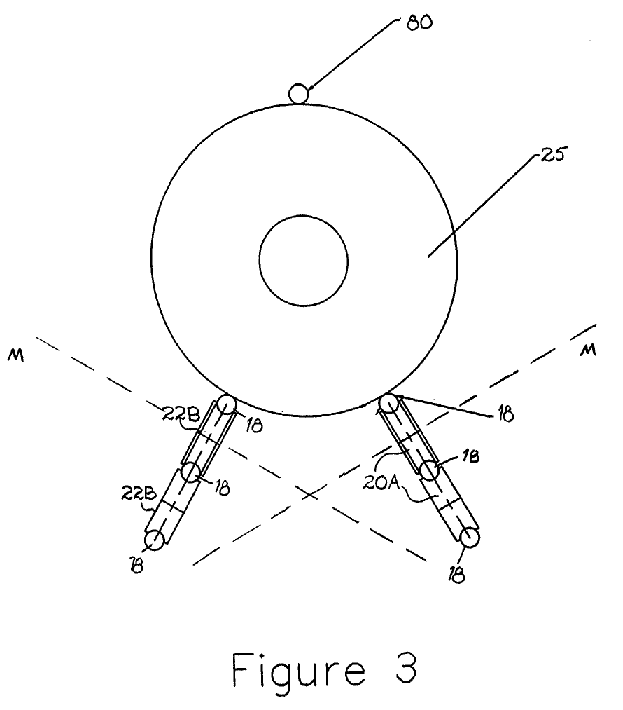

A main conveyor 18 is preferably supported for rotation and guided about axes L and M (shown in FIGS. 2 and 3) by first and second sets of feed side pulleys 14A, 14B and by first and second sets of product side pulleys 16A, 16B. The first and second sets of feed side pulleys 14A, 14B are preferably mounted to rotate about their own axes adjacent the feed conveyor 30 and the first and second sets of product side pulleys 14A, 14B are preferably mounted to rotate about their own axes a distance downstream from the first and second sets of feed side pulleys 14A, 14B. As will be explained in greater detail below and as shown in FIG. 2, the main conveyor 18 preferably includes a first conveyor belt 38 and a second conveyor belt 40 which are preferably substantially parallel for substantial portions of their respective lengths. The first belt 38 is preferably supported for rotation and guided about the first and second axes L, M by the first set of feed side pulleys 14A and the first set of product side pulleys 16A. The second belt 40 is preferably supported for rotation and guided about the first and second axes L, M by the second set of feed side pulleys 14B and the second set of product side pulleys 16B. As shown in FIGS. 1-9, each of the first and second sets of feed side pulleys 14A, 14B and the first and second sets of product side pulleys 16A, 16B in the illustrated preferred embodiment includes two pulleys 14A, 14B and 16A, 16B, respectively, although a different number of feed and product side pulleys can be employed at each end of the main conveyor 18 as desired. Depending at least partially upon the manner in which the first and second conveyor belts 38, 40 are trained to a driving device (described in greater detail below) and the location of the driving device, each of the first and second conveyor belts 38, 40 can rotate about a single pulley at each end of the main conveyor 18 or about any number of pulleys in these same locations.

Preferably, each of the individual pulleys of the first and second sets of feed side pulleys 14A, 14B and the first and second sets of product side pulleys 16A, 16B are substantially similar to the first and second pulleys 52, 54 described above, and can be rotatably mounted in any number of well-known manners, such as about respective or shared axles. In various alternative embodiments, each of the individual pulleys of the first and second sets of feed side pulleys 14A, 14B and the first and second sets of product side pulleys 16A, 16B can be relatively cylindrical elongated members. For example, each of the individual pulleys of the first and second sets of feed side pulleys 14A, 14B and the first and second sets of product side pulleys 16A, 16B can be shafts, bars, drums, axles, and the like, which are preferably rotatable about their own axes. As used herein and in the appended claims, the term “pulley” is used to refer to any element employed to guide a surface conveyor of any type. Therefore, the term “pulley” is intended to encompass such elements as wheels, shafts, axles, drums, and bars, each of which can be employed to perform such a function.

Preferably, the main conveyor 18 is passed around and is held relatively taut by the first and second sets of feed side pulleys 14A, 14B and the first and second sets of product side pulleys 16A, 16B. As shown in FIG. 2, the first belt 38 is preferably threaded across the first set of feed side pulleys 14A and across the first set of product side pulleys 16A. In a similar manner, the second belt 40 is preferably threaded across the second set of feed side pulleys 14B and across the second set of product side pulleys 16B.

Preferably, there is sufficient friction between the first and second sets of feed side pulleys 14A, 14B and/or the first and second sets of product side pulleys 16A, 16B so that the main conveyor 18 can frictionally engage one or more of the individual pulleys of the first and second sets of feed side pulleys 14A, 14B and/or the first and second sets of product side pulleys 16A, 16B. If desired, the main conveyor 18 can be driven by rotating any of the individual pulleys of the first and second sets of feed side pulleys 14A, 14B and/or the first and second sets of product side pulleys 16A, 16B with any conventional driving device (such as a electric or hydraulic motor). If desired, one or more of the individual pulleys of the first and second sets of feed side pulleys 14A, 14B and/or the first and second sets of product side pulleys 16A, 16B can have teeth which engage the inside of the main conveyor 18.

Depending at least in part upon the shape and dimensions of the product passed through the apparatus 12 and the shape and dimensions of the conveyor belt 38 used, the main conveyor 18 can be defined by a single conveyor belt 38 supported by a single set of feed side pulleys 14 and a single set of product side pulleys 16. Alternatively, more than two belts 38, 40 can be trained about upstream and downstream pulleys in a manner similar to the belts 38, 40 described above and illustrated in FIGS. 1-9. In any of these embodiments, the main conveyor 18 can also be supported by a feed side pulley 14 adjacent the feed conveyor 30 and a single product side pulley 16 a distance downstream from the feed conveyor 30. In still other embodiments, feed and/or product side pulleys 14, 16 (not shown) can also or alternatively be spaced along the length of the main conveyor 18 to support and guide the main conveyor 18.

With reference again to the preferred embodiment illustrated in FIGS. 1-9, the main conveyor 18 preferably includes first and second conveyor belts 38, 40. As mentioned above, the first conveyor 38 extends around the first set of feed side pulleys 14A and the first set of product side pulleys 16A. Similarly, the second conveyor 40 preferably extends around the second set of feed side pulleys 14B and the second set of product side pulleys 16B.

FIGS. 1 and 2 show two different manners of routing the first and second conveyor belts 38, 40 around the first and second sets of feed side pulleys 14A, 14B and the first and second sets of product side pulleys 16A, 16B. FIG. 1 shows a side view of the product separation apparatus 12 in which the first and second belts 38, 40 are routed above the motors 99 (described below) by the first and second sets of feed side pulleys 14A, 14B and by the first and second sets of product side pulleys 16A, 16B. FIG. 2 shows an arrangement in which the first and second belts 38, 40 do not extend above the motors 99. Instead, the first and second belts 38, 40 are routed below the first, second and third conveyor sections 18A, 18B, 18C (described below).

In some preferred embodiments of the present invention, the first and second sets of feed side pulleys 14A, 14B are angled or canted so that the first and second sets of feed side pulleys 14A, 14B form part of an inverted V when viewed along the main conveyor 18. Preferably, the first and second sets of feed side pulleys 14A, 14B are arranged in a manner substantially similar to the arrangement of the first and second guide assemblies 20, 22 shown in FIG. 3. Additionally, the upper pulleys of the first and second sets of feed side pulleys 14A, 14B are preferably spaced a first distance apart. The first distance is preferably smaller than the width of the logs 25, the trim 26, and the product units 24 so that the upper pulleys of the first and second sets of feed side pulleys 14A, 14B and the first and second conveyors 38, 40 can support the logs 25, the trim 26, and the product units 24 as they travel through the product separation apparatus 12. The lower pulleys of the first and second sets of feed side pulleys 14A, 14B are preferably spaced a second greater distance apart. In this manner, the lower pulleys of the first and second sets of feed side pulleys 14A, 14B can direct the first and second conveyors 38, 40 around the upper pulleys of the first and second sets of product side pulleys 14A, 14B without interfering with the operation of the upper pulleys of the first and second sets of feed side pulleys 14A, 14B.

In a similar manner, the first and second sets of product side pulleys 16A, 16B can be angled or canted so that the first and second sets of product side pulleys 16A, 16B form part of an inverted V when viewed along the main conveyor 18. Preferably, the first and second sets of product side pulleys 16A, 16B are also arranged in a manner substantially similar to the arrangement of the first and second guide assemblies 20, 22 shown in FIG. 3. Additionally, the upper pulleys of the first and second sets of product side pulleys 16A, 16B are preferably spaced a first distance apart. This distance is preferably smaller than the width of the logs 25, the trim 26, and the product units 24 so that the upper pulleys of the first and second sets of product side pulleys 16A, 16B and the first and second conveyors 38, 40 can support the logs 25, the trim 26, and the product units 24 as they travel through the product separation apparatus 12. The lower pulleys of the first and second sets of product side pulleys 16A, 16B are preferably spaced a second greater distance apart. In this manner, the lower pulleys of the first and second sets of feed side pulleys 16A, 16B can direct the first and second conveyors 38, 40 around the upper pulleys of the first and second sets of product side pulleys 16A, 16B without interfering with the operation of the upper pulleys of the first and second sets of feed side pulleys 16A, 16B.

The first and second conveyor belts 38, 40 are preferably conventional conveyor belts or bands which are formed into loops. The first and second belts 38, 40 can be made of any suitable material and may or may not be reinforced (e.g., with fibrous materials, strands, or additives). For example, the first and second belts 38, 40 can be made of rubber, nylon, plastic, carbon fiber, and the like. As shown in FIG. 2, the belts 38, 40 can be shaped as cords, strips or bands. However, the first and second belts 38, 40 can have any number of shapes and sizes and can have any number of different cross sectional shapes, including rectangular, trapezoidal, round, oval, and polygonal, and irregular shapes. Finally, the first and second belts 38, 40 can be toothed belts, V-belts, flat belts, cords, and the like. Alternatively, the first and second belts 38, 40 can be a series of interconnected elements which form a loop. For example, the main conveyor 18 can be formed by interconnecting a series of elements to form a chain, mesh material, or a series of connected elements defining a tabletop conveyor. In still other embodiments, the first and second belts 38, 40 can be cable, woven or non-woven fibers or strands, and the like.

FIGS. 1-9 show an embodiment of the present invention in which a portion of the main conveyor 18 is adjacent the feed side conveyor 30. More particularly, the first and second sets of feed side pulleys 14A, 14B preferably hold at least a portion of the main conveyor 18 adjacent the second pulley 54 to receive trim 26 and product units 24 from the feed conveyor 30. In some preferred embodiments the position of the main conveyor 18 and/or the position of the guide belt 80 (described in more detail below) is adjustable with respect to the main conveyor 18, log clamp 36, or any other part of upstream and downstream equipment in order to ensure smooth transition of product to and from the main conveyor 18. By way of example only, a conveyor adjusting jack 73 (shown in FIG. 1) is employed in the illustrated preferred embodiment to adjust the position of the main conveyor 18 with respect to the log clamp 36. Adjusting jacks and their manner of connection and operation are well known to those skilled in the art and are not therefore described further herein.

With continued reference to FIGS. 1-9, the main conveyor 18 is preferably directed around or through guides 42 located between the feed side pulleys 14A, 14B and the product side pulleys 16A, 16B. The guides 42 are preferably pulleys which guide the first and second belts 38, 40 to and from a belt driving device (described in greater detail below). The guides 42 can be employed to direct the main conveyor 18 around various elements within the product separation apparatus 12 and/or various other elements located around the product separation apparatus 12. In various alternative embodiments, the main conveyor 18 and particularly the belts 38, 40 can be routed in any number of different manners to travel around any number of different obstructions and to operate effectively within a given work area. In the embodiment of the present invention shown in FIGS. 1-9, the first and second belts 38, 40 are routed across the guides 42 along a path extending above the rest of the product separation apparatus 12. However, in alternative embodiments, the first and second belts 38, 40 can be routed in any number of different manners by any number of guides 42. In still other embodiments, the product separation apparatus 12 can operate without guides 42.

Preferably, the main conveyor 18 extends through first and second guide assemblies 20, 22 (discussed in greater detail below). As shown in FIGS. 1-9, the main conveyor 18 preferably includes a first conveyor section 18A, a second conveyor section 18B, and a third conveyor section 18C. The first conveyor section 18A is preferably defined by the first and second sets of feed side pulleys 14A, 14B and by the second guide assemblies 22A, 22B. The second conveyor section 18B is preferably defined by the first and second sets of product side pulleys 16A, 16B and by the first guide assemblies 20A, 20B. The third section 18C of the main conveyor 18 preferably extends between the first and second guide assemblies 20A, 20B, 22A, 22B.

As shown in FIGS. 1-9, the first guide assemblies 20A, 20B are preferably positioned between the first and second sets of feed side pulleys 14A, 14B and the first and second sets of product side pulleys 16A, 16B. In this regard, each first guide assembly 20A, 20B preferably corresponds with and shares a conveyor belt 38, 40 with a feed side pulley 14A, 14B and a product side pulley 16A, 16B. In the illustrated preferred embodiment of FIGS. 1-9 for example, one of the first guide assemblies 20A supports and guides the first belt 38 of the main conveyor 18 and the other first guide assembly 20B supports and guides the second belt 40 of the main conveyor 18. As shown in FIGS. 1-9, each of the first guide assemblies 20A, 20B preferably includes two pulleys 44 rotatably mounted in any number of well-known manners. In alternative embodiments, the first guide assemblies 20A, 20B have different numbers of pulleys employed to perform the same or similar functions as the first guide assemblies 20A, 20B (described in greater detail below).

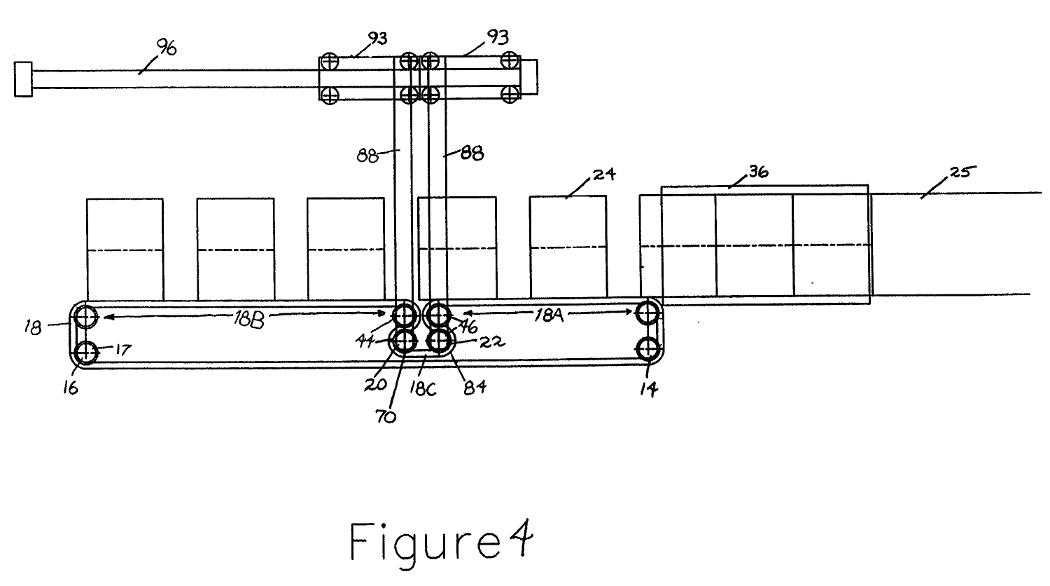

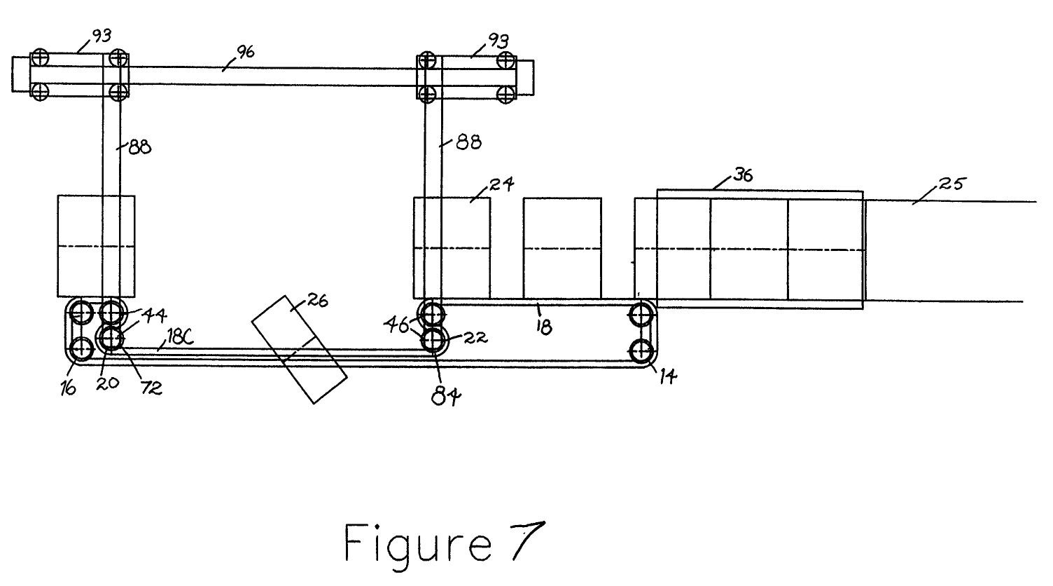

The first guide assemblies 20A, 20B are preferably moveable between a first position 70 and a second position 72 as shown in FIGS. 4-5 and 7-9, respectively. When the first guide assemblies 20A, 20B are in the first position 70 (as shown in FIGS. 1, 4, and 5), the first guide assemblies 20A, 20B are preferably spaced between the first and second sets of feed side pulleys 14A, 14B and the first and second sets of product side pulleys 16A, 16B. Alternatively, when the first guide assemblies 20A, 20B are moved into the second position 72 (as shown in FIGS. 7-9), the first guide assemblies 20A, 20B are preferably moved relatively closer to the first and second sets of product side pulleys 16A, 16B and the first guide assemblies 20A, 20B are moved a greater distance from the first and second sets of feed side pulleys 14A, 14B.

As shown in FIGS. 1-9, the second guide assemblies 22A, 22B are preferably positioned between the first and second sets of feed side pulleys 14A, 14B and the first and second sets of product side pulleys 16A, 16B. In this regard, each second guide assembly 22A, 22B preferably corresponds with and shares a conveyor belt 38, 40 with a feed side pulley 14A, 14B and a product side pulley 16A, 16B. In the illustrated preferred embodiment of FIGS. 1-9 for example, one of the second guide assemblies 22A supports and guides the first belt 38 of the main conveyor 18 and the other second guide assembly 22B supports and guides the second belt 40 of the main conveyor 18. As shown in FIGS. 1-9, each of the second guide assemblies 22A, 22B preferably includes two pulleys 44 rotatably mounted in any number of well-known manners. In alternative embodiments, the second guide assemblies 22A, 22B have different numbers of pulleys employed to perform the same or similar functions as the second guide assemblies 22A, 22B (described in greater detail below).

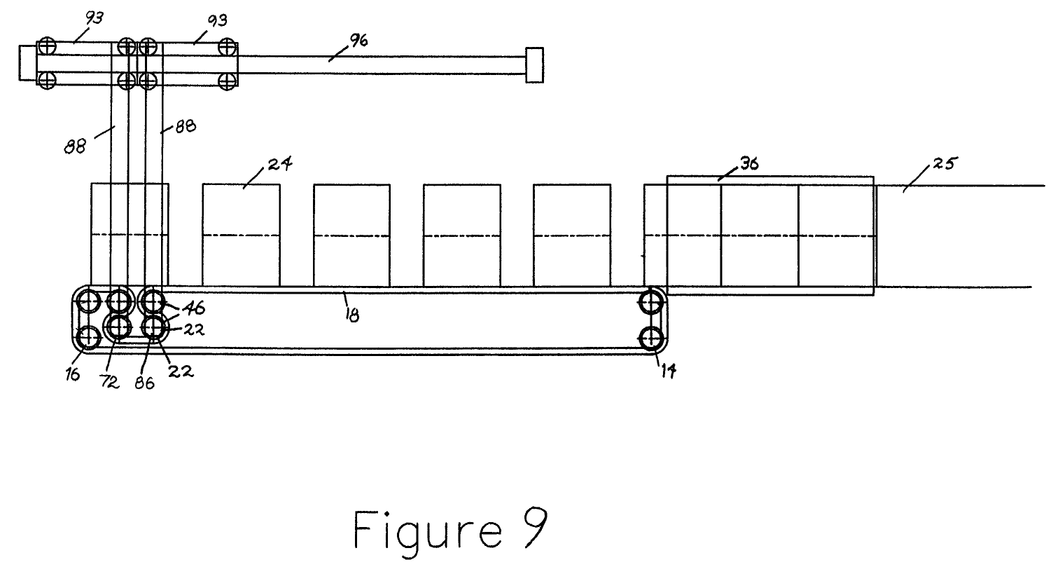

The second guide assemblies 22A, 22B are preferably moveable between a first position 84 (shown in FIGS. 1 and 4-7) and a second position 86 (shown in FIG. 9). When the second guide assemblies 22A, 22B are in the first position 84, the second guide assemblies 22A, 22B are preferably spaced between the first and second sets of feed side pulleys 14A, 14B and the first and second sets of product side pulleys 16A, 16B. Alternatively, when the second guide assemblies 22A, 22B are in the second position 86, the second guide assemblies 22A, 22B are preferably moved closer to the first and second product side pulleys 16A, 16B and the second guide assemblies 22A, 22B are moved a greater distance from the first and second sets of feed side pulleys 14A, 14B.

As discussed above and shown in FIG. 2, the first conveyor section 18A is preferably defined by the first and second sets of feed side pulleys 14A, 14B and the second guide assemblies 22A, 22B. More particularly, the first conveyor section 18A includes a portion of the first belt 38 defined by the first set of feed side pulleys 14A and a first guide assembly 20A. Preferably, the first conveyor section 18A also includes a portion of the second belt 40 defined by the second set of feed side pulleys 14B and another first guide assembly 20B.

Also as discussed above and shown in FIG. 2, the second conveyor section 18B is preferably defined by the first and second sets of product side pulleys 16A, 16B and the first guide assemblies 20A, 20B. More particularly, the second conveyor section 18B includes a portion of the first belt 38 defined by the first set of product side pulleys 16A and a first guide assembly 20A. Preferably, the second conveyor section 18B also includes a portion of the second belt 40 defined by the second set of product side pulleys 16B and another first guide assembly 20B.

Finally, as discussed above and shown in FIG. 2, the third section 18C is preferably defined by the first and second guide assemblies 20A, 20B, 22A, 22B. More particularly, the third conveyor section 18C includes a portion of the first belt 38 defined by a first guide assembly 20A and a second guide assembly 22A. Preferably, the third conveyor section 18C also includes a portion of the second belt 40 defined by another first guide assembly 20B and another second guide assembly 22B.

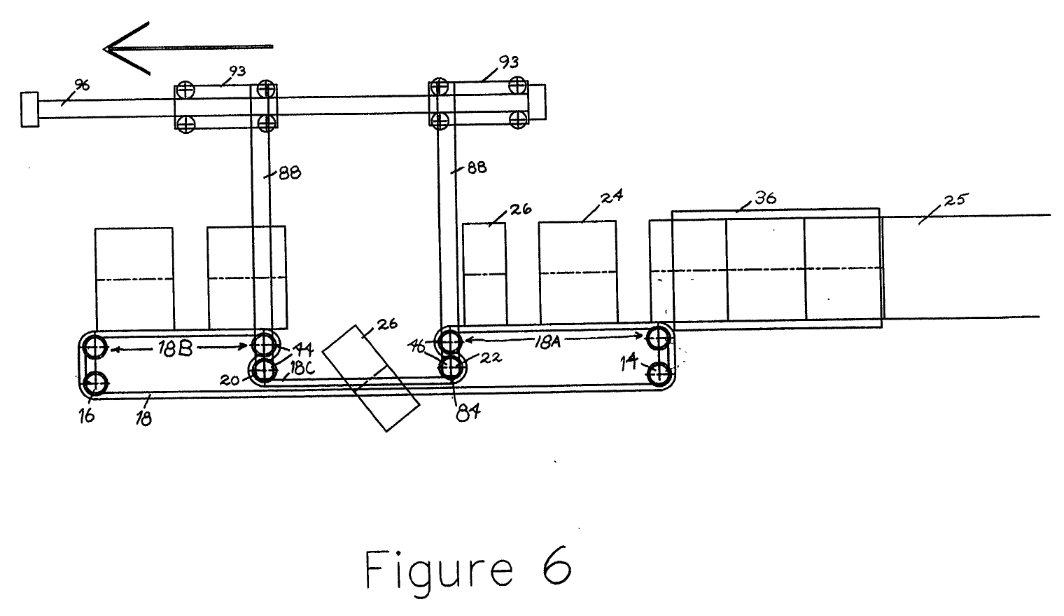

As shown in FIGS. 1-9, the first and second guide assemblies 20A, 20B, 22A, 22B preferably operate together to separate trim 26, undesirable product, or to otherwise divert product from product units 24. Preferably, when product units 24 enter the product separation apparatus 12, the first guide assemblies 20A, 20B and the second guide assemblies 22A, 22B are in the first positions 70, 84, respectively (as shown in FIGS. 1, 4, and 5). As trim 26 (or undesirable product or product to be diverted) approaches the second guide assemblies 22A, 22B, the first guide assemblies 20A, 20B preferably move toward the second position 72 (as shown in FIG. 6). In this manner, the trim 26 preferably falls between the first and second guide assemblies 20A, 20B, 22A, 22B, as shown in FIG. 6.

Referring now to FIGS. 2 and 3, the first and second guide assemblies 20A, 20B, 22A, 22B are preferably canted or angled. In particular, the upper portions of the first guide assemblies 20A, 20B are preferably angled inward and the lower portions of the first guide assemblies 20A, 20B are preferably angled outward. Similarly, the upper portions of the second guide assemblies 22A, 22B are preferably angled inward and the lower portions of the second guide assemblies 22A, 22B are preferably angle outward. In this manner, the first and second guide assemblies 20, 22 preferably have inverted V configurations. This arrangement causes the first and second belts 38, 40 to be spaced a first distance apart in the first and second conveyor sections 18A, 18B and causes the first and second belts 38, 40 to be spaced a second larger distance apart in the third conveyor section 18C. The first distance is preferably relatively small so that the first and second belts 38, 40 are close enough to support the logs 25. The second distance is preferably large enough that pieces of trim 26 can pass between the first and second belts 38, 40 in the third conveyor section 18C.

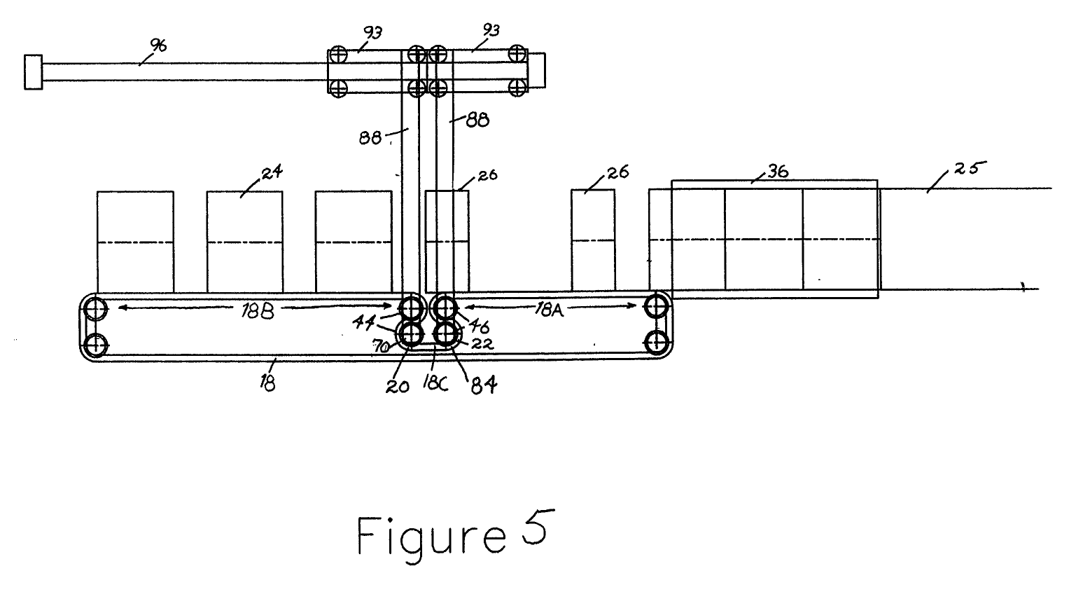

In general, trim 26 is removed from the front and/or back ends of logs 25. In the illustrated preferred embodiment for example, trim 26 is removed from the front and back of each log 25. Therefore, two pieces of trim 26 generally enter the product separation apparatus 12 in succession: one at the end of a log 25 and one at the beginning of the next log 25. Therefore, as shown in FIGS. 6 and 7, the first guide assemblies 20A, 20B preferably remain in or continue to move toward the second position 72 or otherwise are spaced from the second guide assemblies 22A, 22B even after a piece of trim 26 has fallen between the first and second guide assemblies 20A, 20B, 22A, 22B. In this manner, the second piece of trim 26 falls between the first and second guide assemblies 20A, 20B, 22A, 22B and is removed from the product separation apparatus 12 as shown in FIGS. 5 and 6.

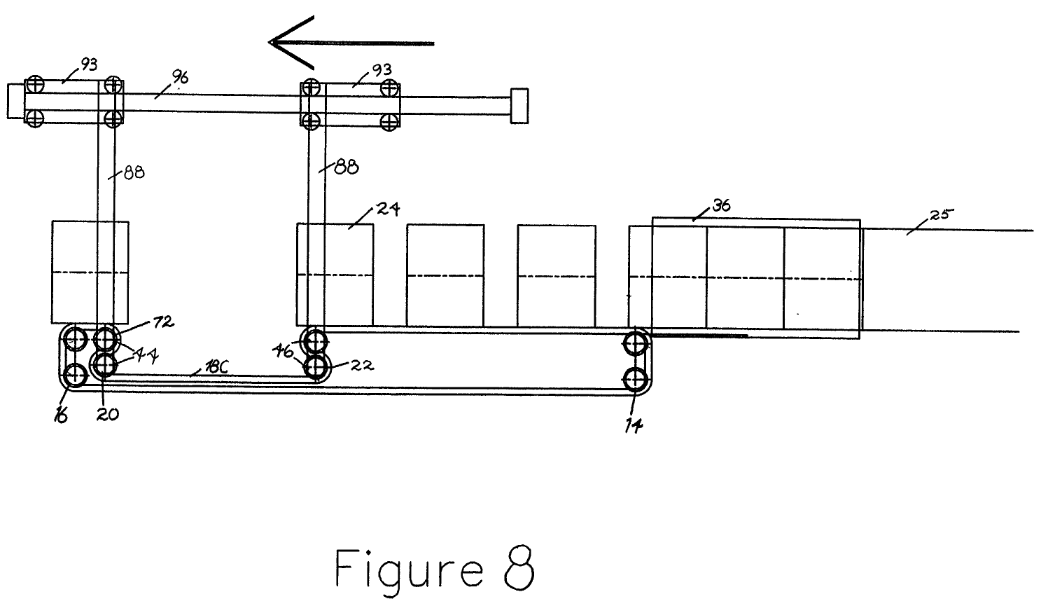

With reference to FIGS. 8 and 9, after the second piece of trim 26 is removed from the product separation apparatus 12, the second guide assembly 22 preferably moves from the first position 84 to the second position 86 so that product units 24 do not fall between the first and second guide assemblies 20, 22. In this manner, the first and second guide assemblies 20A, 20B, 22A, 22B are moved into the second positions 72, 86 and product units 24 can cross between the first and second conveyor sections 18A, 18B. Finally, the first and second guide assemblies 20A, 20B, 22A, 22B preferably move together back into the first positions 70, 84, respectively.

In the illustrated embodiment by way of example only, actuators 97(shown in FIG. 1), are operable to move the first and second guide assemblies 20A, 20B, 22A, 22B between their respective first and second positions 70, 72 and 84, 86. In this embodiment, worm drives 95 are powered by motors 99, each worm drive 95 having a beam, frame, or other preferably rigid connection to a carriage 93 on a track 96. The carriage 93 is preferably movable along the track 96 by movement of the worm drive 95 (controlled by a system controller, which is preferably a programmable processor, a timing element, one or more optical or mechanical sensors as is well known in the art). Preferably, movement of the carriages 93 along the tracks 96 is assisted by friction reducing elements such as bearings, rollers, slide elements, and the like.

A number of other drive devices and assemblies can also or alternatively be connected to the carriages 93 to move them along their tracks 96, each of which functions to move the carriages 93 and each of which falls within the spirit and scope of the present invention. For example, pneumatic or hydraulic actuators, magnetic rails, gear and rack assemblies, and the like can instead be used. In addition, each carriage 93 can have its own track 96 as shown in the illustrated embodiment in FIG. 1. Alternatively, both carriages 93 can be moveable along the same track 96.

In the illustrated embodiment of FIGS. 1-9, the first and second guide assemblies 20A, 20B, 22A, 22B are each preferably coupled to carriages 93 for movement with the carriages 93 along the tracks 96. The carriages 93 are preferably coupled to the first and second guide assemblies 20A, 20B, 22A, 22B by frames 88. In alternative embodiments, other conventional stabilizing elements, such as bars, plates, arms, and the like can instead be used to connect the first and second guide assemblies 20A, 20B, 22A, 22B to the carriages 93. In some preferred embodiments, the pulleys 44 of the first guide assemblies 20A, 20B and the pulleys 46 of the second guide assemblies 22A, 22B are rotatably coupled to frames 88 for rotation about their own axes and for movement with the carriages 93 along the tracks 96. However, in alternative embodiments, the pulleys 44, 46 can be coupled to the frames 88 in any conventional manner, such as for example, by securing their axles thereto.

The product separation apparatus 12 also preferably includes a product conveyor 32. The product conveyor 32 preferably removes product units 24 from the product separation apparatus 12 and transfers the product units 24 to downstream operations. Preferably, the product conveyor 32 is adjacent the first and second sets of product side pulleys 16A, 16B to receive product units 24 from the second conveyor section 18B.

In the preferred embodiment of FIG. 2, the product conveyor 32 includes a belt 33 which is passed about a first pulley 90 and a second pulley 92. The first and second pulleys 90, 92 are preferably rotatable about their own axes and are preferably substantially similar to the first and second pulleys 52, 54 of the feed conveyor 30 as discussed above. The descriptions of the various embodiments and forms of the first and second pulleys 52, 54 of the feed conveyor 30 are therefore incorporated herein.

Preferably, the belt 33 is passed around the first and second pulleys 90, 92 and is held relatively taut by the first and second pulleys 90, 92. More preferably, there is sufficient friction between the inside of the belt 33 and the first and second pulleys 90, 92 so that the belt 33 can frictionally engage the first and second pulleys 90, 92. The belt 33 can take any form and can be driven in any of the manners described above with reference to the feed conveyor 30. In this regard, rotation of one or both of the first and second pulleys 90, 92 preferably moves the belt 33 along a path 94 (represented by an arrow). If desired, additional pulleys (not shown) can be positioned between the first and second pulleys 90, 92 to provide additional support to the belt 33 and/or to drive the belt 33 along the path 94.

In some preferred embodiments of the present invention such as that shown in FIGS. 19, the product separation apparatus 12 also includes a trim conveyor 34 (see FIG. 1). The term “trim conveyor” is employed herein only for purposes of identification, and is understood to encompass conveyors used to divert desirable and undesirable product that may or may not include trim 26. The trim conveyor 34 can take any of the forms described above with reference to the feed conveyor 30 and/or the product conveyor 32.

In the illustrated preferred embodiment, the trim conveyor 34 preferably includes a belt 35 passed about a first pulley 76 and a second pulley 78. The first and second pulleys 76, 78 are preferably rotatable about their own axes and preferably are substantially similar to the first and second pulleys 52, 54 of the feed conveyor 30. The descriptions of the various embodiments and forms of the first and second pulleys 52, 54 of the feed conveyor 30 are therefore incorporated herein.

Preferably, the belt 35 is passed around the first and second pulleys 76, 78 and is held relatively taut by the first and second pulleys 76, 78. More preferably, there is significant friction between the inside of the belt 35 and the first and second pulleys 76, 78 so that the belt 35 can frictionally engage the first and second pulleys 76, 78. The belt 35 can take any form and can be driven in any of the manners described above with reference to the feed conveyor 30. In this regard, rotation of one or both of the first and second pulleys 76, 78 preferably drives the belt 35.

In the illustrated embodiments, the trim conveyor 34 is preferably positioned between and at a distance below the first and second sets of feed side pulleys 14A, 14B and the first and second sets of product side pulleys 16A, 16B. As discussed above, trim 26 preferably does not pass from the first conveyor section 18A to the second conveyor section 18B, but instead falls between the first guide assemblies 20A, 20B and the second guide assemblies 22A, 22B onto the trim conveyor 34. The trim conveyor 34 preferably removes the trim 26 or other desirable or undesirable product 26 from the product separation apparatus 12.

As mentioned above, trim 26, undesirable product, or other product that is to be diverted preferably falls between the first and second guide assemblies 20A, 20B, 22A, 22B. In the illustrated preferred embodiment, this material falls through the third conveyor section 18C. In some alternative embodiments, trim 26, undesirable product or other product that is to be diverted preferably falls between the first and second guide assemblies 20A, 20B, 22A, 22B onto the third section 18C and a pusher (not shown) preferably removes this material from the third conveyor section 18C. The trim pusher can be a pusher plate, a swinging, rotating, or robotic arm, a blast of air or other fluid, and the like.

FIG. 1 shows an embodiment in which two drive members 58 rotate about their own axes to rotate the main conveyor 18 about the axes L, M. The drive members 58 preferably include a prime mover and a speed reduction pulley. The prime mover can take any conventional form, including without limitation an electric or hydraulic motor, an internal-combustion engine and the like. Additional prime movers preferably move the feed conveyor 30 along the path 56, move the product conveyor 32 along the path 94, and/or operate the trim conveyor 34. In some embodiments, a single prime mover can be used to drive two or more of the conveyors described herein.

In the illustrated embodiment, a guide belt 80 preferably extends across and a distance above the main conveyor 18. The guide belt 80 can take any of the forms and can be driven in any of the manners described above with reference to the belts 38, 40 of the main conveyor 18. The guide belt 80 preferably passes about at least one pulley 81, 82 which trains the guide belt 80 along and a distance from the main conveyor belts 38, 40. As with the belts 38, 40 of the main conveyor 18, the guide belt 80 preferably runs to and is driven by the drive members 58 (e.g., about a pulley driven by a prime mover as discussed above).

Rotation of the pulleys 81, 82 preferably moves the belt 80 along a path 74 (represented by an arrow). In alternative embodiments of the present invention, additional pulleys (not shown) can be positioned between the first and second pulleys 81, 82 to provide additional support to the belt 80 and/or to drive the belt 80 along the path 74.

In operation, the guide belt 80 preferably travels across the first and second pulleys 81, 82 adjacent to the main conveyor 18 as shown in FIG. 1. In this manner, the guide belt 80 can guide product units 24, logs 25, trim 26, and the like into and through the product separation apparatus 12. Specifically, the guide belt 80 preferably contacts and retains product units 24, logs 25, trim 26 and the like upon the main conveyor belts 38, 40 as this material passes through the product separation apparatus 12. This function can be particularly useful to prevent product units 24 from dropping between the first and second conveyor sections 18A, 18B along with the trim 26. The guide belt 80 preferably extends along substantially the entire main conveyor 18, but in other embodiments can extend along any part or all of the feed conveyor 30, the product conveyor 32, and/or the trim conveyor 34.

One guide belt 80 is illustrated in the embodiment of FIG. 1. However, it should be noted that one or more additional guide belts can be employed in addition to the single guide belt 80 described above.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

For example, as noted above, the present invention can be used to remove trim, product units, and logs in other than rolled form (e.g., folded and interfolded napkins, facial tissue, paper towels, stacks of paper, etc.). The shape and design of various portions of the product separation apparatus 12 can therefore take forms better suited for the product being trimmed. Similarly, the feed conveyor 30, the product conveyor 32, and/or the trim conveyor 34 can be replaced with or alternatively can include a series of powered or unpowered rollers.

In addition, any one or more of the various operations of the present invention can be performed manually if desired. However, most preferred embodiments of the present invention employ a controller (not shown) for automated operation of the main conveyor 18, the first actuator 36, the second actuator 38, the first guide assemblies, 20A, 20B, the second guide assemblies 22A, 22B, the cutting device 28, the feed conveyor 30, the trim conveyor 34, and/or the product conveyor 60. The system controller is preferably connected to and controls the timing and speed of each of these elements in a manner well known to those skilled in the art. Further, in some embodiments the controller is adjustable to change system operation (e.g. for handling larger or smaller logs 25, to operate at higher or lower production speeds, to produce larger or smaller product units 24, and the like).

What is claimed is:

1. A trim removal apparatus comprising:
a first pulley;
a second pulley;
a conveyor extending around the first and second pulleys, the conveyor movable about the first and second pulleys;
a first pulley assembly, the conveyor extending through the first pulley assembly, the first pulley assembly and the first pulley defining a first section of the conveyor therebetween;
a second pulley assembly, the conveyor extending through the second pulley assembly, the second pulley assembly and the second pulley defining a second section of the conveyor therebetween, the first pulley assembly and the second pulley assembly defining a third section of the conveyor therebetween, at least one of the first pulley assembly and the second pulley assembly moveable between a first position in which the first section and the second sections are adjacent to one another and a second position in which the first section and the second section are spaced a distance apart.

2. The trim removal apparatus of claim 1, wherein the conveyor is a conveyor belt.

3. The trim removal apparatus of claim 1, wherein the conveyor is a cord.

4. The trim removal apparatus of claim 1, wherein the conveyor includes:
a first endless member extending around the first and second pulleys, the first endless member rotatable about the first and second pulleys; and
a second endless member spaced from the first endless member and extending around third and fourth pulleys, the second endless member rotatable about the third and fourth pulleys.

5. The trim removal apparatus of claim 4, wherein:
the first and second endless members are substantially parallel;
the first and second endless members are spaced a second distance apart in the first and second conveyor sections;
the first and second endless members are spaced a third distance apart in the third conveyor section; and
the third distance is greater than the second distance.

6. The trim removal apparatus of claim 5, wherein the conveyor is a first conveyor, the apparatus further comprising a second conveyor running alongside the first conveyor a distance from the first conveyor to at least partially define a product path between the first and second conveyors.

7. The trim removal apparatus of claim 1, wherein the first pulley assembly includes a third pulley and a fourth pulley through which the conveyor extends.

8. The trim removal apparatus of claim 7, wherein the second pulley assembly includes a fifth pulley and a sixth pulley through which the conveyor extends.

9. The trim removal apparatus of claim 1, further comprising an actuator, the actuator coupled to at least one of the first and second pulley assemblies to move the at least one of the first and second pulley assemblies.

10. The trim removal apparatus of claim 1, wherein both of the first and second pulley assemblies are moveable between the first and second pulleys.

11. The trim removal apparatus of claim 1, further comprising a controller coupled to at least one of the first and second pulley assemblies to control movement of the at least one of the first and second guide assemblies.

12. The trim removal apparatus of claim 1, wherein the third section is spaced a distance below the second section.

13. The trim removal apparatus of claim 1, further comprising a log saw adjacent to the conveyor.

14. A trim removal apparatus comprising:
first, second, third, and fourth pulleys;
a first guide assembly between the first and second pulleys;
a second guide assembly between the first and second pulleys, the second guide assembly moveable between a first position adjacent to the first guide assembly and a second position spaced a distance from the first position; and
a conveyor including:
a first endless member extending around the first and second pulleys, the first endless member rotatable about the first and second pulleys;
a second endless member extending around the third and fourth pulleys, the second endless member rotatable about the third and fourth pulleys.

15. The trim removal apparatus of claim 14, wherein the conveyor includes:
a first conveyor section defined by a portion of the first endless member between the first pulley and the first guide assembly and by a portion of the second endless member between the third pulley and the second guide assembly;
a second conveyor section defined by a portion of the first endless member between the second pulley and the second guide assembly and by a portion of the second endless member between the fourth pulley and the second guide assembly;
a third conveyor section defined by a portion of each of the first and second endless members between the first and second guide assemblies;
wherein the first and second endless members are spaced a first distance apart in the first and second conveyor sections, a second distance apart in the third conveyor section, the second distance being greater than the first distance.

16. The trim removal apparatus of claim 15, wherein the third conveyor section is spaced a second distance below the second section.

17. The trim removal apparatus of claim 14, wherein the first endless member is a cord.

18. The trim removal apparatus of claim 14, wherein the first endless member is a conveyor belt.

19. The trim removal apparatus of claim 14, wherein the first and second pulleys are defined by the same body.

20. The trim removal apparatus of claim 14, wherein the first guide assembly includes a third pulley and a fourth pulley.

21. The trim removal apparatus of claim 20, wherein the second guide assembly includes a fifth pulley and a sixth pulley.

22. The trim removal apparatus of claim 14, further comprising an actuator, the actuator coupled to at least one of the first and second guide assemblies to move the at least one of the first and second guide assemblies.

23. The trim removal apparatus of claim 14, wherein the first guide assembly is moveable between the first and second pulleys.

24. The trim removal apparatus of claim 14, further comprising a controller coupled to at least one of the first and second guide assemblies to control movement of the at least one of the first and second guide assemblies.

25. The trim removal apparatus of claim 14, further comprising a log saw adjacent to the conveyor.

26. A trim removal apparatus for separating trim material from a web product, the trim removal apparatus comprising:
a first pulley;
a second pulley spaced from the first pulley;
a conveyor rotatable about the first and second pulleys, the conveyor including:
a first conveyor section extending from the first pulley;
a second conveyor section extending from the second pulley; and
a third conveyor section located between the first and second conveyor sections and positioned below the first and second conveyor sections, the conveyor moveable between a first state in which the first section is adjacent to the second conveyor section and a second state in which the first conveyor section is spaced a distance from the second conveyor section.

27. The trim removal apparatus of claim 26, wherein the conveyor is at least one conveyor belt.

28. The trim removal apparatus of claim 26, wherein the conveyor is at least one cord.

29. The trim removal apparatus of claim 26, wherein the conveyor includes a first endless member rotatable about the first and second pulleys and a second endless member rotatable about a third pulley and a fourth pulley.

30. The trim removal apparatus of claim 29, wherein:
the first and second endless members are substantially parallel;
the first and second endless members are spaced a second distance apart in the first and second conveyor sections;
the first and second endless members are spaced a third distance apart in the third conveyor section; and
the third distance is greater than the second distance.

31. The trim removal apparatus of claim 26, further comprising:
a first guide assembly, the conveyor extending through the first guide assembly,
a second guide assembly, the conveyor extending through the second guide assembly;
at least one of the first guide assembly and the second guide assembly moveable between the first and second pulleys, the first pulley and the first guide assembly defining the first conveyor section therebetween, the second pulley and the second guide assembly defining the second conveyor section therebetween, the first and second guide assemblies defining the third conveyor section therebetween;
the first and second guide assemblies movable adjacent to one another to define the first state of the conveyor; and
the first and second guide assemblies movable apart from one another to define the second state of the conveyor.

32. The trim removal apparatus of claim 31, wherein both of the guide assemblies are moveable between the first and second pulleys.

33. The trim removal apparatus of claim 31, wherein the first guide assembly includes a third pulley and a fourth pulley.

34. The trim removal apparatus of claim 33, wherein the second guide assembly includes a fifth pulley and a sixth pulley.

35. The trim removal apparatus of claim 26, further comprising an actuator, the actuator coupled to at least one of the first and second guide assemblies to move the at least one of the first and second guide assemblies.

36. The trim removal apparatus of claim 26, further comprising a controller coupled to at least one of the first and second guide assemblies to control movement of the at least one of the first and second guide assemblies.

37. The trim removal apparatus of claim 26, further comprising a log saw adjacent to the conveyor.

38. A method of separating a trim from a log with a trim removal apparatus, the trim removal apparatus including a conveyor extending through a first guide assembly and a second guide assembly, the conveyor having a first section, a second section, and a third section, and the first guide assembly having a first position adjacent to the second guide assembly and a second position spaced a distance from the second guide assembly, the method comprising:
moving the first guide assembly along the conveyor to the first position;
passing product from the first section to the second section;
moving the first guide assembly along the conveyor to the second position;
forming a gap between the first and second sections;
passing trim through the gap; and
removing the trim from the apparatus between the first section and the second section.

39. The method of claim 38, wherein the trim removal apparatus includes a pulley and wherein the conveyor extends across the pulley, the method further comprising rotating the conveyor about the pulley.

40. The method of claim 38, further comprising:
lengthening the first section;
shortening the third section;
shortening the first section; and
lengthening the third section.

41. The method of claim 38, further comprising:
moving the second guide assembly along the conveyor;
lengthening the second section;
shortening the third section;
shortening the second section; and
lengthening the third section.

42. The method of claim 38, wherein the trim removal apparatus includes a log saw positioned along the endless member, the method further comprising cutting the log with the log saw.

43. The method of claim 38, wherein the trim removal apparatus includes an actuator coupled to the first guide assembly, the method further comprising moving the first guide assembly between the first position and the second position with the actuator.

44. The method of claim 38, wherein the trim removal apparatus includes a controller coupled to the first guide assembly, the method further comprising controlling movement of the first guide assembly with the controller.

45. The method of claim 38, wherein the conveyor includes a first endless member extending through the first and second guide assemblies, and a second endless member extending through third and fourth guide assemblies, the method further comprising moving the first and second guide assemblies along the first and second endless members, respectively.

46. A method of separating trim from a log with a trim removal apparatus, the trim removal apparatus including a conveyor defined at least partially by at least two endless members passed about pulleys, the method comprising:
moving web product across the conveyor;
moving at least one of the pulleys between a first position and a second position to define a gap between sections of the conveyor;
separating trim from the logs; and
removing the trim from the apparatus through the gap between sections of the conveyor.

47. The method of claim 46, wherein:
the conveyor has first and second ends; and
moving at least one of the pulleys includes moving the at least one of the pulleys between the first and second ends of the conveyor.

48. The method of claim 47, wherein the conveyor has a first section defined between the first end of the conveyor and a first pulley located between the first and second ends of the conveyor, a second section defined between the second end of the conveyor and a second pulley located between the first pulley and the second end of the conveyor, and a third section defined between the first and second pulleys, the method further comprising:
moving the first pulley to the first position;
lengthening the first section;
shortening the third section;
moving the first pulley to the second position;
shortening the first section; and
lengthening the third section.

49. The method of claim 48, further comprising:
moving the second pulley with respect to the first pulley;
lengthening the second section;
shortening the third section;
shortening the second section; and
lengthening the third section.

50. The method of claim 47, further comprising rotating the conveyor about at least one of the first and second pulleys.

51. The method of claim 46, wherein the trim removal apparatus includes a log saw positioned along the conveyor, the method further comprising cutting the log with the log saw.

52. The method of claim 46, wherein the trim removal apparatus includes an actuator coupled to the at least one of the pulleys, the method further comprising moving the at least one of the pulleys between the first position and the second position with the actuator.

53. The method of claim 46, wherein the trim removal apparatus includes a controller coupled to the at least one of the pulleys, the method further comprising controlling movement of the at least one of the pulleys with the controller.
